(19) United States
(12) Patent Application Publication
(10) Pub. No.: US 2004/0025750 A1
(43) Pub. Date: Feb. 12, 2004

(54) Method and device for producing printing inks

(76) Inventors: Bernhard Stalder, Niederuzwil (CH); Roland Halter, St. Gallen (CH); Walter Almer, Oberuzwil (CH); Roland Tschudy, Oberuzwil (CH)

Correspondence Address: BURNS, DOANE, SWECKER & MATHIS, L.L.P., P.O. Box 1404, Alexandria, VA, 22313-1404, US

(21) Appl. No.: 10/440,259

(22) Filed: May 19, 2003

(30) Foreign Application Priority Data
Nov. 17, 2000 (DE) 100 57 327.4

(51) Int. Cl. C09D 11/00

(52) U.S. Cl. 106/499; 106/31.6

(57) ABSTRACT

The invention relates to a method for producing a printing ink or a printing ink concentrate. The inventive method includes the following steps that are successively carried out: an aqueous slurry that contains lipophilic coloring pigments and a lipophilic binder is fed to a first treatment area; the aqueous coloring pigment slurry and the binder that have been fed to the first treatment area are subjected in the first treatment area to shearing and extensional flows so that an at least partial flushing of the lipophilic coloring pigments from the aqueous slurry with the lipophilic binder takes place; downstream of the first treatment area water stemming from the aqueous slurry is removed for the first time; the partially dehydrated flowable mass obtained in the first treatment area is fed to a second treatment area in which the flowable mass is subjected to shearing, extensional and compressive effects; water released as a separate phase in the first treatment area is removed from the flowable mass for the second time by way of partial flushing; the substantially dehydrated flowable mass in which the lipophilic coloring pigments are dispersed in the lipophilic binder is removed as an intermediate or final product and collected.

This application claims priority under 35 U.S.C. §119 to German Application 100 54 327.4 filed in Germany on Nov. 17, 2000, and under 35 U.S.C. §120 to PCT/CHO1/00558 filed as an International Application on Sep. 17, 2001 designating the U.S., the entire contents of which are hereby incorporated by reference in their entireties.

### BACKGROUND

This invention relates to a method and a device for producing printing inks or printing ink concentrates.

Colored pigments are used in the production of printing inks; a coupling step is performed in a dilute aqueous medium for synthesis of these pigments so that after synthesis the molecular aggregates are present in an aqueous medium forming a suspension or slurry of solid particles. The pigment weight amount that can be achieved in this synthesis is therefore only a few percent. The molecules of which these colored pigments consist belong to the group of azo compounds or polycyclic compounds, for example. Typical examples include monoazo yellow, monoazo orange, diazo, -naphthol, naphthol AS, benzimidazolone, diazo condensation pigments, metal complex pigments, isoindolinone pigments as representatives of the azo compounds or phthalocyanine, quinacridone, perylene, perinone, thioindigo, anthraquinone, anthrapyrimidine, flavanthrone, pyranthrone, anthanthrone, dioxazine, triarylcarbonium, quinophthalone or diketopyrrolopyrrole pigments as representatives of the polycyclic compounds.

Since these color-imparting substances are not dissolved in molecular form but instead are in the form of organic crystals composed of these molecules, their physical properties and in particular their color properties depend not only on the respective molecular structure but also in addition on the properties of the respective crystal structure. For example in the case of pigments of copper(II)-phthalocyanine, there is a reddish blue α-modification, a greenish blue β-modification and a reddish blue ε-modification, whereas pigments of unsubstituted linear quinacridone have a reddish violet β-modification and a red γ-modification.

The color properties of these pigments may be determined on the one hand by targeted substitution of individual constituents of their molecules in the synthesis reactor. On the other hand however their color properties may also be influenced after synthesis in further processing to form printing inks by conversion from one crystal modification to another by selecting and maintaining the physical conditions required for the respective modification for this process (primarily temperature and pressure) accordingly.

An important aspect in the production of printing inks is the pigment size. Usually especially small pigments are preferred.

In conventional printing ink production, the aqueous suspension (slurry) originating from synthesis is processed in a filter press to form a pressed cake of pigment with a pigment content of approximately 20-30 wt %. A portion of the salts originating from synthesis are removed in the water pressed out of this cake.

This cake still has a high water content (70-80 wt %) and is then either (a) dried in a dryer and next ground in a dry state to form a powdered pigment which together with a binder (e.g., oil) is a “pigment concentrate” as the end product or (b) the pressed cake is mixed in a kneader with the binder, whereby because of the greater affinity of the binder for the pigment, the pigment is rewetted (flushed) from the hydrophilic phase (water) into the lipophilic phase (binder) so that additional water is released as pigment-free separate phase and can be decanted, so that the product must be kneaded and decanted several times in succession to remove most of the water from the product. The end product here is the same as in (a) but is usually designated as pigment paste or “flush paste.”

Although rewetting (flushing) eliminates the energy-intensive steps of drying and then grinding, they are replaced by several steps of kneading and decanting. Kneading is also a very energy-intensive and uneconomical process step. As a rule, the binder must also be added in several stages after these steps to achieve the desired low water content of the end product. In addition to remove the residual water from the product in the kneader it must be heated and degassed in vacuum. It is nevertheless difficult to achieve a water content less than approximately 3 wt %.

In addition to the unreasonably high energy expenditure in drying and in kneading, these conventional methods have numerous “transfer points” at which the product must be “forward” from process step to process step, so that ultimately the overall process is uneconomical and furthermore it is difficult to guarantee a uniform quality of the end product.

### SUMMARY

Exemplary embodiments are directed to a method and a device for producing printing ink so that the disadvantages of the state of the art as mentioned above can be avoided.

According to this invention, in contrast with the state of the art discussed in the preamble, water is removed from the product only gradually in the course of the process, so that flushing of the pigments into the thin slurry originating directly from the synthesis reactor takes place in the first processing area. Thus in contrast with (a), this eliminates the energy expended in drying with subsequent dry milling and in contrast with (b) it eliminates the energy expenditure of kneading a pressed cake and the multiple time-consuming decanting operations in alternation with renewed kneading.

In somewhat simpler terms thus in this invention first the pigments are flushed and then salts are washed out of the product, whereas in the state of the art the product is washed first and then flushed.

Since the product is in a highly fluid state during the entire process according to this invention (it is preferably in the form of an aqueous slurry with a pigment content of less 10%), a continuous process management from synthesis (production of the colored pigment) to the end product (production of the printing ink) can be achieved in a closed system with the equipment according to this invention.

Preferably in the initial removal of water, most of the water contained in the fluid mass in a first processing area is removed, and then in the second processing area water is again added to the free-flowing mass, preferably using distilled water and optionally also heated water. This makes it possible to wash out the salts contained in the product especially well.

Then expediently in the second processing area downstream from the second water removal, water is removed a third time, preferably heating the free-flowing mass moderately after the second water removal and performing the third water removal in the form of degassing of water vapor. It is especially advantageous if the third water removal from the second processing area is supported by a vacuum in the area of the third water removal. This yields a product having a very low water content.

Expediently the shear rates in effect in the first processing area in the range of 1,000/s to 100,000/s, preferably 1,000/s to 50,000/s, the intensity of the shear flow and/or strain flow in the first processing area preferably increasing steadily from a minimum to a maximum and then declining again steadily or abruptly.

The lipophilic colored pigments are typically solids which are transferred from the aqueous phase to the oily phase of an oily binder in flushing in the first processing area. Several binders may also be mixed together before being mixed with finely divided solids with another liquid.

In an especially preferred embodiment of the method according to this invention, the maximum shear rate in the first processing area in a first partial area amounts to at most approximately 5 times the minimum shear rate in a second partial area of the first processing area and the volume of the first partial area is at most approximately 3 times the volume of the second partial area.

The temperature in the first processing area amounts to 0 to 200° C., preferably 40° C. to 90° C. This prevents the organic molecules of the pigments, some of which do not have very good heat resistance, from being damaged, which would lead to color distortion in the end product even if only a small portion of the molecules are destroyed.

Preferably other binders and/or oils as well as printing ink additives are added to the free-flowing mass in the second processing area, so that a finished printing ink is obtained.

Expediently with the device according to this invention, the two coaxial rotating elements include a cylinder and a cone or they may both be cones so that the interspace (first processing area) between the coaxial rotating elements tapers or widens in the direction of conveyance of the product, preferably one of the rotating elements being a rotor and the other being a stator. This permits effective and gentle flushing of the pigments in the first processing area.

If working with shear rates below approximately 3,000/s, then preferably collision bodies (balls) are used in the interspace, whereas at shear rates of more than approximately 3,000/s it is possible to omit the use of balls in the interspace.

In an especially preferred embodiment of the device according to this invention, pin-like elevations which extend into the interface and move past one another in rotation of the rotating elements are provided on the surface of the respective rotating element, with collision bodies (e.g., balls) which may collide with the surface and/or pin-like elevations of the rotating elements being provided as needed in the interspace. This contributes to intensification of the mixing effect during flushing.

Preferably the gap width of the interspace can be adjusted by a displacement of the two rotating elements relative to one another along their common axis of rotation A. Through a suitable combination of the rotor rotational speed and the gap width, it is possible to adjust suitable shear rates over a large range in the interspace of the first processing area. An expedient adjustment range for the gap width ranges from approximately 1 mm to approximately to approximately 5 mm.

The second processing area is preferably the process space of an extruder, whereby the first processing area and the second processing area may be arranged coaxially, one immediately after the other in such a way that the axis of rotation A and the longitudinal axis of the extruder are colinear. The extruder may be a multi-screw extruder.

An especially compact design of the device according to this invention is characterized in that the housing of the successive processing areas is a common 1-piece housing whose upstream first housing section corresponds to the stator and whose downstream second housing part corresponds to the extruder housing. This design eliminates the need for connecting lines or connecting channels.

### BRIEF DESCRIPTION OF THE DRAWINGS

Additional advantages, features and possible applications of this invention are derived from the following description on the basis of the drawing, which shows:

FIG. 1 shows a schematic diagram of the method according to the state of the art;

FIG. 2 shows a schematic diagram of an exemplary method according to this invention; and

FIGS. 3a and 3b show a schematic diagram of one exemplary embodiment of one part of the device according to this invention.

### DETAILED DESCRIPTION OF THE PREFERRED EMBODIMENT

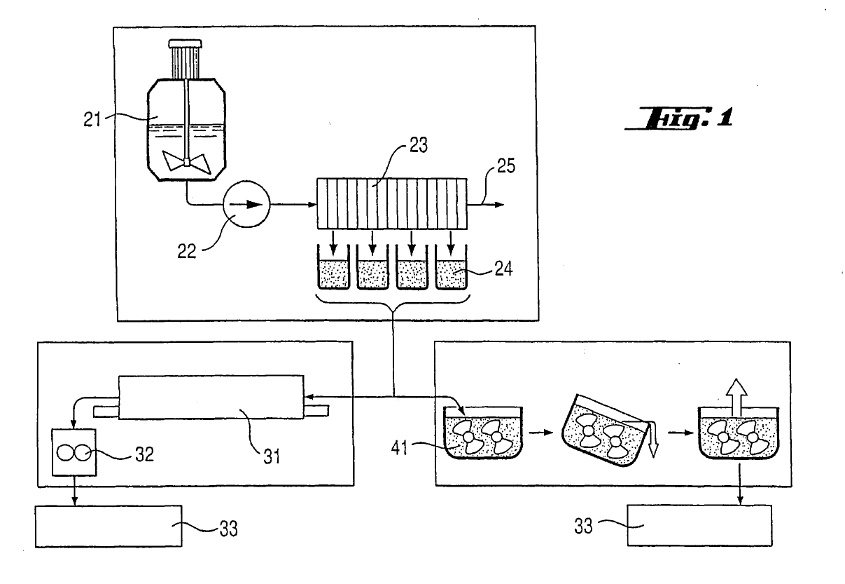

FIG. 1 shows two state-of-the-art methods. In both methods, the colored pigments obtained in aqueous emulsion (slurry) in synthesis in reactor 21 are sent to a filter press 23 by means of a pump 22 and are pressed to pressed pigment cakes 24 having a water content of 70-80%, whereby a portion of the salts are also removed from the synthesis product together with the wastewater 25 pressed out of the cake.

In one of the known methods (left branch) this pressed cake 24 of pigment is sent to a dryer 31 for drying, whereupon the dried mass is sent to a roll mill 32 for dry milling. Dry milling yields a powdered pigment 33. In another process step (not shown) this powdered pigment is then mixed with a lipophilic binder and optionally with printing ink additives.

In the other of the known methods (right branch) this pigment pressed cake 24 is combined with a lipophilic binder in a Z kneader 41 and is kneaded thoroughly, occasionally decanting the water released by flushing. In another step the contents of the Z kneader 41 are degassed in vacuo, yielding an oily pigment paste 33, also known as flush paste which is then also mixed with printing ink additives optionally in another process step (not shown).

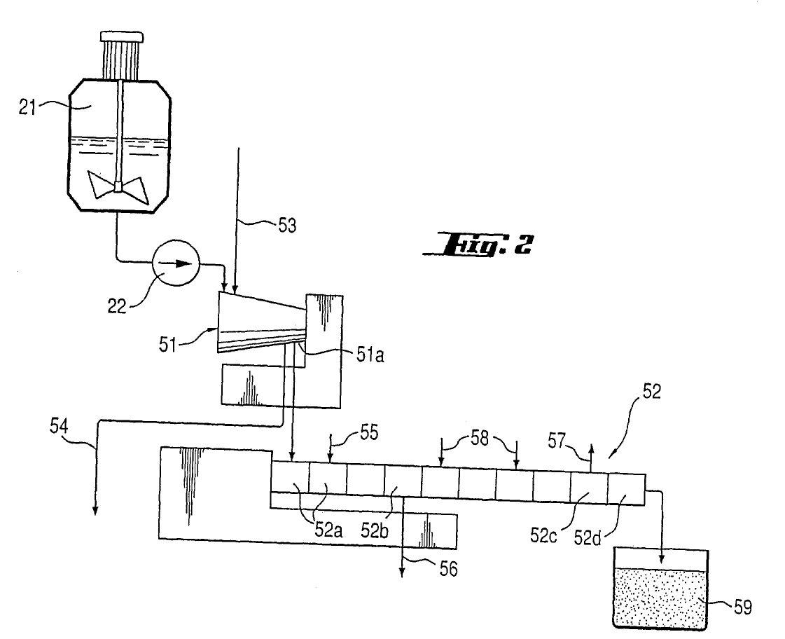

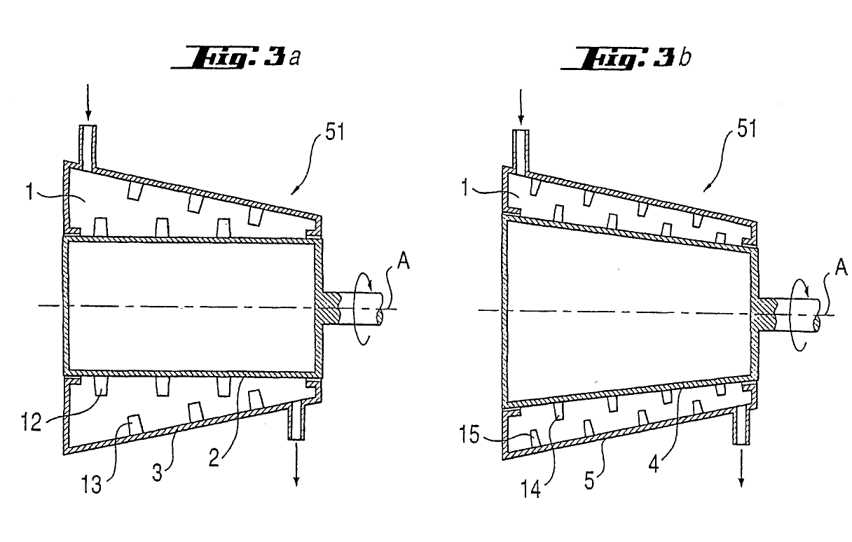

FIG. 2 illustrates an exemplary method according to this invention. The slurry containing approximately 4% colored pigment originating from synthesis reactor 21 is sent through a line by a pump 22 to the first processing area 51 which is designed as a special mixing device with a shearing and straying action using conical-conical or cylindrical-cylindrical geometry (see FIGS. 3a, 3b), e.g., as a special type of a ball mill or a pinned disc mill. In addition a lipophilic binder 53 is added to the first processing area 51. Flushing takes place mainly in the first processing area. At the end 51a of the first processing area 51, water 54 is removed for the first time together with salts from the free-flowing mass which then goes through a channel from end 51a of the first processing area 51 to the input area 52a of the second processing area 52 which is preferably formed by an extruder. Fresh water, i.e., largely deionized water, optionally even distilled water 55 is sent again to processing area 52 in its inlet area 52a and then is removed again as residual water in an area 52b of the second processing area 52. Finally in another area 52c of the second processing area 52 the slurry is degassed in a vacuum 57, the degassing being supported by heating. Other binders and/or oils as well as various printing ink additives are added 58 as needed in the processing area 52, so that a complete printing ink 59 or a printing ink concentrate can be removed at the outlet 52a of the second processing area 52.

FIG. 3a shows schematically a cylindrical-conical embodiment of the first processing area 51. This area is determined here by an interspace 1 between an inner cylinder 2 and an outer cone 3, both of which are rotatably mounted about a common axis A. Pin-like elevations 12 and 13 are located on the surfaces of cylinder 2 and cone 3.

FIG. 3b illustrates schematically a conical-conical embodiment of the first processing area 51, which is also formed here by an interspace 1, but in this case the interspace is between an inner cone 4 and an outer cone 5, both being mounted so they can rotate about a common axis A. Pin-like elevations 14 and 15 are provided on the surfaces of the inner cone 4 and the outer cone 5.

During operation, the slurry to be processed is pumped from left to right through the interspace 1 by pump 22. In doing so, the slurry is exposed to greater and lesser shearing rates in alternation on its path through interspace 1 from left to right in both the cylindrical-conical design as well as the conical-conical design because areas of greater and lower shear rate alternate because of the pin-like elevations 12, 13 and 14, 15. Pump 22 can overcome the internal friction of the slurry, the friction between the slurry and the inside surfaces of the processing area 51 as well as the centrifugal effect due to the conical geometry.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A method of producing a printing ink or a printing ink concentrate comprising, in the following order:
adding a lipophilic binder and an aqueous slurry containing a lipophilic colored pigment to a first processing area;
in the first processing area, imposing shear flows and strain flows upon the aqueous slurry and the binder which were added to the first processing area, so that at least partial flushing of the lipophilic colored pigment out of the aqueous slurry is accomplished with the lipophilic binder;
after the first processing area, removing water originating from the aqueous slurry for a first time;
sending a partially dehydrated free-flowing mass obtained from the first processing area to a second processing area where the free-flowing mass is exposed to a shearing, straining and compression effect and, for a second time, removing water released as a separate phase by the partial flushing in the first processing area from the free-flowing mass; and
removing and collecting, as an intermediate product or as an end product, the free-flowing mass which has been at least partially removed of water and in which the lipophilic colored pigment is dispersed in the lipophilic binder.

2. The method according to claim 1, wherein a colored pigment content of the aqueous slurry at an entrance to the first processing area amounts to 2 to 10%.

3. The method according to claim 1, wherein the water removed the first time represents a majority of the water contained in the free-flowing mass in the first processing area, and water is added back to the free-flowing mass in the second processing area.

4. The method according to claim 3, wherein the added back water is distilled water.

5. The method according to claim 3, wherein the added back water is heated water.

6. The method according to claim 1, wherein water is removed a third time in the second processing area as a third removal of water after the second removal of water.

7. The method according to claim 6, wherein the free-flowing mass is heated after the second removal of water and the third removal of water takes place as degassing water vapor.

8. The method according to claim 6, wherein the third removal of water from the second processing area is supported by a vacuum in an area of the third water removal.

9. The method according to claim 1, wherein shear rates acting in the first processing area are in a range of 1,000/s to 100,000/s.

10. The method according to claim 1, wherein an intensity of the shear flow and/or strain flow in the first processing area increases steadily from a minimum to a maximum or vice versa and then decreases again steadily or abruptly increases.

11. The method according to claim 1, wherein the lipophilic colored pigment is a solid which is transferred from an aqueous phase to an oil phase of an oily binder in the first processing area in flushing.

12. The method according to claim 1, wherein several liquids are mixed together before being combined with another liquid with finely dispersed solids.

13. The method according to claim 1, wherein a maximum shear rate in a first partial area in the first processing area amounts to at most approximately 5 times a minimum shear rate in a second partial area of the first processing area, and a volume of the first partial area amounts to at most approximately 3 times a volume of the second partial area.

14. The method according to claim 1, wherein a temperature in the first processing area is 0 to 200° C.

15. The method according to claim 1, wherein additional binders and/or oils and printing ink additives are added to the free-flowing mass in the second processing area.

16. The method according to claim 1, wherein a temperature determination is performed in the first and/or second processing area(s).

17. The method according to claim 16, wherein the temperature determination is used as a basis for temperature regulation of the method.

18. A device for carrying out the method of claim 1, wherein the first processing area is an interspace between two coaxial rotating elements which can rotate about their common axis (A) relative to one another.

19. The device according to claim 18, wherein a gap width of the interspace is adjustable.

20. The device according to claim 18, wherein the two coaxial rotating elements are each a cylinder and a cone, or both are cones, such that the interspace between the coaxial rotating elements tapers or widens in a direction of product conveyance.

21. The device according claim 18, wherein one of the rotating elements is a rotor and another is a stator.

22. The device according to claim 18, wherein pin-like elevations extend from a surface of each respective rotating element into the interspace and move past one another with rotation of the rotating elements.

23. The device according to claim 22, wherein collision bodies are located in the interspace and can collide with the surface and/or the pin-like elevations of the rotating elements.

24. The device according to claim 19, wherein the gap width of the interspace is adjustable by displacement of the two coaxial rotating elements relative to one another along a common axis of rotation (A).

25. The device according to claim 18, wherein the second processing area is a process space of an extruder.

26. The device according to claim 25, wherein the first processing area and the second processing area are arranged coaxially and directly following one another, an axis of rotation (A) of the coaxial rotating elements and a longitudinal axis of the extruder being colinear.

27. The device according to claim 25, wherein the extruder is a multi-screw extruder.

28. The device according to claim 26, wherein a housing of successive processing areas is a common housing whose upstream first housing part corresponds to a stator and whose downstream second housing part corresponds to a extruder housing.

29. The device according to claim 25, wherein at least one means is provided for temperature determination in the first processing area and/or in the second processing area.

30. The method according to claim 1, wherein a colored pigment content of the aqueous slurry at an entrance to the first processing area amounts to 3 to 6%

31. The method according to claim 1, wherein shear rates acting in the first processing area are in a range of 1,000/s and 50,000/s.

32. The method according to claim 1, wherein a temperature in the first processing area is 40to 90° C.
